(19) United States
(12) Patent Application Publication
(10) Pub. No.: US 2005/0041629 A1
(43) Pub. Date: Feb. 24, 2005

(54) Method for supporting variable data rates in a cdma system

(76) Inventor: Xiaoyang Lee, Monmouth Junction, NJ (US)

Correspondence Address: HARNESS, DICKEY & PIERCE, P.L.C., P.O. BOX 828, BLOOMFIELD HILLS, MI, 48303, US

(21) Appl. No.: 10/485,971

(22) PCT Filed: Aug. 7, 2001
(86) PCT No.: PCT/US01/41616

(51) Int. Cl. H04B 7/216

(52) U.S. Cl. 370/342

(57) ABSTRACT

An improved method (10) is provided for supporting variable data rates between a transmitter and a receiver in a code division multiple access (CDMA) data communication system. The method includes: providing a control channel (12) and at least one application data channel between the transmitter and the receiver, transmitting user data (14) from the transmitter via the application data channel to the receiver; transmitting a data rate indicator (16) from the transmitter via the control channel to the receiver; where the data rate indicator is indicative of the data rate at which the user data is transmitted by the transmitter; and using the data rate indicator to decode the user data (18) at the receiver.

### FIELD OF THE INVENTION

The present invention relates generally to code division multiple access (CDMA) and, more particularly, a method for supporting variable data rates in a CDMA data communication system.

### BACKGROUND OF THE INVENTION

Wireless telecommunication systems have grown dramatically in the last decade as the reliability and capacity of such systems have improved. Wireless communication systems are being utilized in a variety of applications where land line based systems are impractical or impossible to use. Wireless communication systems have also become an economically viable alternative to replacing aging telephone lines and outdated telephone equipment. Unfortunately, the portion of the RF spectrum available for use by wireless communication systems is a limited critical resource which must be shared amongst a variety of service providers. Thus, there is a constant desire to improve the efficiency and capacity of wireless communication systems.

Code division multiple access (CDMA) has shown particular promise for improving the efficiency and capacity of wireless communication systems. CDMA is a data communications technology based on the principals of spread spectrum communication. In a CDMA system, the same portion of the frequency spectrum is used for communication by all of the system subscriber units. Each subscriber unit's baseband data signal is multiplied by a code sequence which has a much higher rate than the data rate and is commonly referred to as a “spreading code”. This coding results in a much wider transmission spectrum than the spectrum of the baseband data signal, and hence this technique is called “spread spectrum”. Subscriber units and their communications can be discriminated by assigning a unique spreading code to each communication link. Since communications from different subscriber units are sent over the same frequency band, CDMA allows more users to access wireless networks simultaneously than with other conventional data communication techniques, such as time division multiple access or frequency division multiple access.

From time to time, users may have the need to transmit data at different data rates in a CDMA system. Variable rate service may vary the data rate from frame to frame depending on the application. In one known approach, blind-rate detection is used to determine the data rate for a given frame received at a receiver. In this approach, the receiver must make a determination of the data rate of the received frame before processing the frame. Each frame must be separately processed at each possible data rate before a determination is made regarding which data rate was utilized by the transmitter. The greater the number of data rates supported by the service, the more processing power and more complex the receiver. Therefore, it is desirable to provide a less complicated and highly reliable method for supporting variable data rates in CDMA system.

### SUMMARY OF THE INVENTION

In accordance with the present invention, an improved method is provided for supporting variable data rates between a transmitter and a receiver in a code division multiple access (CDMA) data communication system. The method includes: providing a control channel and at least one application data channel between the transmitter and the receiver; transmitting user data from the transmitter via the application data channel to the receiver; transmitting a data rate indicator from the transmitter via the control channel to the receiver, where the data rate indicator is indicative of the data rate at which the user data is transmitted by the transmitter; and using the data rate indicator to decode the user data at the receiver.

For a more complete understanding of the invention, its objects and advantages, reference may be had to the following specification and to the accompanying drawings.

### BRIEF DESCRIPTION OF THE DRAWINGS

FIG. 1 is a flowchart illustrating a method for supporting variable data rates in accordance with the present invention; and

FIG. 2 is a diagram illustrating the four different dedicated uplink channels that have been proposed for CDMA2000.

### DETAILED DESCRIPTION OF THE PREFERRED EMBODIMENTS

CDMA technology is typically deployed in cellular-type wireless network communication systems. In a cellular-type system, the service area is geographically divided into several adjacent zones of coverage called cells. Each cell in the network has at least one base station that establishes communication links with various mobile stations located in or nearby the cell. Base stations and mobile stations are transceivers capable of sending and receiving data signals as is well known in the art. As a mobile station moves from one cell to an adjacent cell, any communication link with the mobile station is maintained by passing the link to a base station in the adjacent cell. In this way, a mobile station can move from cell to cell without interruption to its communication link. While the following description is provided with reference to cellular-type wireless network system, it is readily understood that CDMA technology may be utilized in other types of data communication systems.

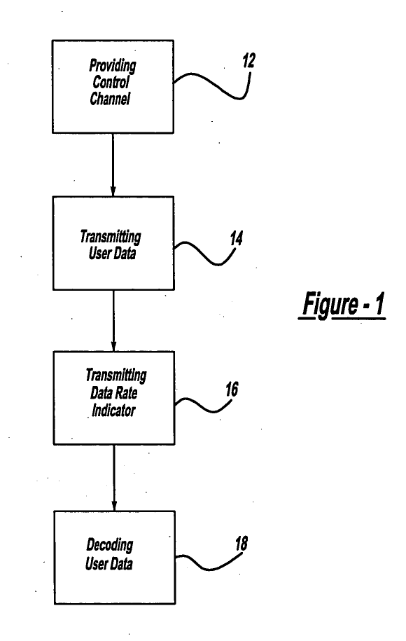

FIG. 1 is a flowchart illustrating an improved method for supporting variable data rate transmissions between a transmitter and a receiver in a CDMA data communication system. The communication link is configured to provide a dedicated control channel and at least one application data traffic channel between the transmitter and the receiver as noted in step 12. It is envisioned that the control channel will operate at a fixed data rate; whereas the application data channel can support variable data rates.

Data is transmitted in blocks of bits called frames, such that a data rate is specified as the number of bits transmitted per frame. To support variable rate transmissions, a data rate indicator is transmitted 14 by the transmitter via the control channel to the receiver simultaneously with the user data being transmitted 16 by the transmitter via the application data channel to the receiver. In accordance with the present invention, the frame size employed by the control channel is shorter than the frame size employed by the application data channel.

A four bit binary indicator is preferably used to transmit the data rate to the receiver. The value of the indicator correlates to a particular data rate (i.e., the number of bits per frame) and a corresponding frame duration. In this example, a ‘0000’ value for the indicator is indicative of the highest supported data rate and a ‘1111’ value is indicative of the lowest supported data rate. The data rate indicator as well as the corresponding data rate and frame duration are stored in a look-up table residing at the receiver. It is envisioned that the data rates are ordered from highest to lowest in look-up table. In an alternative embodiment, the data rate indicator may embody the actual data rate used by the transmitter.

Upon receipt, the receiver decodes the data rate indicator received from the transmitter. Once the data rate is determined, the receiver can then decode the user data received via the application data channel from the transmitter as shown at step 18. In this way, the user data payload can be varied frame to frame. Although the data rate indicator only needs to be transmitted when the data rate changes, it is envisioned that a data rate indicator may also be transmitted for each user data payload transmitted between the transmitter and the receiver.

In the context of cellular-type network systems, base stations and mobile stations are each capable of performing transmitting and receiving functions. Transmissions from a base station to a mobile station are referred to as downlinks or forward channel communication links; whereas transmissions from a mobile station to a base station are referred to uplinks or reverse channel communication links. Thus, it is to understood that the above-described methodology is applicable to transmissions in either direction.

Various wideband CDMA standards have been proposed for use in third generation wireless personnel communication systems. Unlike earlier CDMA standards (e.g., IS-95), proposed wideband CDMA standards include one or more dedicated control channels which may be used to transmit a data rate indicator. The wideband CD MA standard proposed by the Telecommunications Industry Association (commonly referred to as “CDMA2000”) is one such wideband CDMA standard. As will be further explained below, the improved methodology of the present invention is particularly suitable for using with CDMA2000. While the following description is provided with reference to CDMA2000, it is readily understood that the present invention may be implemented in the context of other CDMA standards, including (but not limited to) the wideband CDMA standard proposed by ARIB and ETSI as well as the wideband CDMA standard proposed by ETRI.

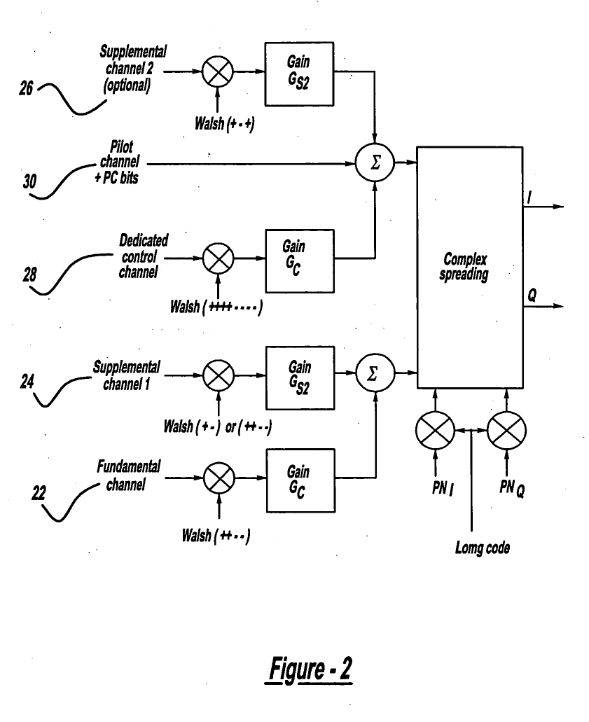

FIG. 2 illustrates the four different dedicated uplink channels that have been proposed for CDMA2000. A fundamental channel 22 and one or more supplemental channels 24 and 26 carry user data. A dedicated control channel 28 carries control information, and a pilot channel 30 carries timing signals for uplink coherent detection. The four uplink channels are separated by Walsh codes as is well known in the art.

In a preferred embodiment of the present invention, user data is transmitted in either the fundamental channel 22 or one of the supplemental channels 24 and 26 in a frame length of 20 ms. The dedicated control channel 28 is then used to transmit the data rate indicator. The dedicated control channel 28 preferably employs a frame length of 5 ms having a fixed data rate.

Similarly, three dedicated downlink channels have been proposed for CDMA2000. Fundamental and supplemental channels carry user data and a dedicated control channel carries control information. In the context of the present invention, the dedicated control channel is used to transmit the data rate indicator

While the invention has been described in its presently preferred form, it will be understood that the invention is capable of modification without departing from the spirit of the invention as set forth in the appended claims.

1. A method for supporting variable data rates between a transmitter and a receiver in a data communication system, comprising:
providing a control channel and at least one application data channel between the transmitter and the receiver, the control channel having a fixed data rate;
transmitting user data from the transmitter via the application data channel to the receiver, where the user data is embodied in a spread-spectrum data signal;
transmitting a data rate indicator from the transmitter via the control channel to the receiver, where the data rate indicator is indicative of the data rate at which the user data is transmitted by the transmitter; and
decoding the user data based in part on the data rate indicator received at the receiver.

2. The method of claim 1 wherein the step of transmitting user data further comprises varying the data rate at which the user data is transmitted to the receiver.

3. The method of claim 1 wherein the step of transmitting a data rate indicator occurs simultaneously to the step of transmitting user data.

4. The method of claim 3 wherein the data rate indicator is transmitted via a data packet having a fixed length that is less than the fixed length of a data packet used to transmit the user data.

5. The method of claim 1 wherein the step of decoding the user data further comprises retrieving a data rate associated with the user data, the data rate being stored in a memory space residing on the receiver, and using the date rate to decode the user data.

6. The method of claim 1 wherein the step of transmitting a data rate indicator further comprises using a dedicated control channel as defined by the CDMA2000 standard.

7. A method for supporting variable data rates in a data communication system employing a wideband code division multiple access (CDMA) scheme, comprising:
transmitting user data via an application data channel, the user data embodied in a spread-spectrum data signal;
transmitting a data rate indicator via a control channel, where the data rate indicator is indicative of the data rate at which the user data is being transmitted; and
decoding the user data based in part on the data rate indicator received at the receiver.

8. The method of claim 7 wherein the step of transmitting user data further comprises using at least one of a dedicated fundamental channel and a dedicated supplemental channel as defined by the CDMA2000 standard.

9. The method of claim 7 wherein the step of transmitting a data rate indicator further comprises using a dedicated control channel as defined by the CDMA2000 standard.

10. The method of claim 7 wherein the wideband CDMA scheme is selected from the group comprising: CDMA2000 standard proposed by TIA, WCDMA standard proposed by ARIB and ETSI, and TTA I and TTA II standards proposed by ETRI.
